(19) United States
(12) Patent Application Publication
(10) Pub. No.: US 2021/0397586 A1
(43) Pub. Date: Dec. 23, 2021

(54) Keeping Object Access on a File Store Consistent With Other File Protocols

(71) Applicant: EMC IP Holding Company LLC, Hopkinton, MA (US)

(72) Inventors: Dipankar Roy, San Jose, CA (US); Sean Lim, Vancouver, WA (US); Peter Van Sandt, Seattle, WA (US); Takafumi Yonekura, Bellevue, WA (US)

(21) Appl. No.: 16/909,170

(22) Filed: Jun. 23, 2020

(51) Int. Cl. G06F 16/176; G06F 16/16

(52) U.S. Cl. CPC G06F 16/1774; G06F 16/162; G06F 16/166

(57) ABSTRACT

Techniques are provided for keeping object access on a file store consistent with other file protocols. In an example, a server that stores data in a file system receives a PUT OBJECT operation to perform, which corresponds to a target file. The server creates a temporary file and writes to the temporary file. After the writing, the server can lock the target file, rename the temporary file to the name of the target file, and unlock the target file. In another example, the server receives a GET OBJECT operation, which corresponds to a target file. The server locks the target file, reads the first file, and releases the lock on the target file. This approach can maintain consistency between object storage operations and file storage operations that are implemented by the server.

### TECHNICAL FIELD

The present application relates generally to performing computer storage operations on a computer file system using multiple computer storage protocols.

### BACKGROUND

A computer file system can perform operations on data that it stores, such as opening a new or existing file, writing data to an opened file, reading data from an opened file, and closing an opened file. In a file system, distinct pieces of data (as well as metadata about the data being stored) can be stored as files, and the files can be stored in a hierarchy of directories. Another type of computer storage system can be object storage.

In an object storage system, data can be stored as an object that can comprise the data being stored, metadata about the data being stored, and a unique identifier for the object relative to other objects in the object storage system. That is, a difference between a file system storage and an object system storage is that, with a file system storage data can be stored hierarchically, and with object system storage, data can be stored in a flat address space.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate keeping object access on a file store consistent with other file protocols, in accordance with certain embodiments of this disclosure;

FIG. 2 illustrates another example system architecture that can facilitate keeping object access on a file store consistent with other file protocols, in accordance with certain embodiments of this disclosure;

FIG. 3 illustrates an example process flow for processing a PUT OBJECT object storage operation, as part of facilitating keeping object access on a file store consistent with other file protocols, in accordance with certain embodiments of this disclosure;

FIG. 4 illustrates another example process flow for processing a PUT OBJECT object storage operation, as part of facilitating keeping object access on a file store consistent with other file protocols, in accordance with certain embodiments of this disclosure;

FIG. 5 illustrates an example process flow for processing a PUT OBJECT object storage operation when a corresponding file is locked, as part of facilitating keeping object access on a file store consistent with other file protocols, in accordance with certain embodiments of this disclosure;

FIG. 6 illustrates an example process flow for processing concurrent PUT OBJECT object storage operations, as part of facilitating keeping object access on a file store consistent with other file protocols, in accordance with certain embodiments of this disclosure;

FIG. 7 illustrates an example process flow for processing a file storage protocol modification operation concurrent with a PUT OBJECT object storage operation on the same file, as part of facilitating keeping object access on a file store consistent with other file protocols, in accordance with certain embodiments of this disclosure;

FIG. 8 illustrates an example process flow for processing a file storage protocol lock operation concurrent with a PUT OBJECT object storage operation on the same file, as part of facilitating keeping object access on a file store consistent with other file protocols, in accordance with certain embodiments of this disclosure;

FIG. 9 illustrates an example process flow for processing a GET OBJECT object storage operation, as part of facilitating keeping object access on a file store consistent with other file protocols, in accordance with certain embodiments of this disclosure;

FIG. 10 illustrates an example process flow for processing a DELETE FILE file storage operation concurrent with a GET OBJECT object storage operation on the same file, as part of facilitating keeping object access on a file store consistent with other file protocols, in accordance with certain embodiments of this disclosure;

FIG. 11 illustrates an example block diagram of a computer operable to execute certain embodiments of this disclosure.

### DETAILED DESCRIPTION

### Ovewview

A computer system can implement an object storage protocol stack on top of a file system storage (such as an ISILON ONEFS file system storage). In such an example, a client computer can send data operations to the computer system that specify object storage operations such as GET OBJECT (to retrieve object contents and metadata), PUT OBJECT (to create or replace an object), COPY OBJECT (to copy an existing object to another object), and DELETE OBJECT (to delete an existing object).

The protocol stack can receive these object storage operations, and convert each of them into one or more corresponding file system operations, such as OPEN FILE (to create a new file or access an existing file), READ FILE (to read the contents of a file), WRITE FILE (to write to the contents of a file), CLOSE FILE (to close an opened file handle for a file), and UNLINK FILE (to delete a file). The protocol stack can then send these corresponding file system operations to a file system driver of the computer system, and the file system driver can implement these file system operations on a file system of the computer system.

In this manner, a client can specify object storage operations to a computer system that implements a file system, and these object storage operations can be effectuated on the file system.

Objects represented using files can be concurrently accessed by both object storage protocols and file storage protocols. Object storage protocols can generally be stateless and omit locking as part of the protocol. File storage protocols (such as a Server Message Block (SMB) protocol and a Network File System (NFS) protocol) can be stateful, and have file and/or directory locking built into the protocol.

In some examples, object writes with an object store protocol are visible only when the write is complete. In such examples, an object that is being written to does not display partial writes. So, reads to an object return a consistent state of the object.

In some examples, file services that do not lock a file representing an object can expose intermediate, inconsistent states that can cause simultaneous object reads to return an inconsistent state. When an object is written via an object storage protocol, it can be either completely overwritten or newly created. In contrast, file storage protocols can concurrently write to a file at specified offsets. This interplay between object storage protocol and file storage protocols can create an inconsistency with an object storage protocol.

An approach to address this inconsistency with an object storage protocol can be to ensure that modifications to a file do not change the object that is written. That is, this approach can ensure that modifications to a file are not visible in data returned by a GET OBJECT object storage operation.

File storage protocols can have mandatory locks, and advisory locks. In some examples, an object storage protocol is not configured to process a lock. In some examples, then, the storage system can ensure that file storage protocols are not compromised due to concurrent access from an object storage protocol.

An approach to facilitate keeping object access on a file store consistent with other file protocols can be as follows. For reading an object, an object storage protocol can perform a GET OBJECT operation. During such times that an object storage protocol GET OBJECT operation is in progress, file storage protocols can be prevented from writing to a file that corresponds to that object. To achieve this, a GET OBJECT operation can take a shared mode lock that denies other protocols concurrent write access. A shared mode lock can allow concurrent read access. This shared mode lock can be held until the GET OBJECT operation completes.

Where a file representing an object is deleted by a file storage protocol during a GET OBJECT operation, that DELETE FILE operation is permitted to occur. The GET OBJECT operation can still complete, since the object does not get deleted until the file representing the object is closed by the GET OBJECT operation. This feature can be part of file system semantics, which keep a file around after deletion until all opens to the file have been closed.

For writing an object, an object storage protocol can perform a PUT OBJECT operation. This PUT OBJECT operation can ensure that partial writes are not visible to object storage clients. This can be achieved by creating a temporary file representing a new object, writing data to it, deleting the original file, and renaming the temporary file as the original file. In some examples, while a PUT OBJECT operation is writing to the temporary file, no lock is taken on the file representing the original object. This can ensure that multiple object storage clients can modify the same object concurrently. Additionally, file storage protocols can be free to modify and take locks on a file representing the original object.

After a PUT OBJECT operation is done with writing to a temporary file, the PUT OBJECT operation can take a shared mode lock on the original file representing the object. In some examples, this shared mode lock does not prevent reads or writes to the original file representing the object, but is meant to detect if another lock is present on the file. A file system protocol client could have taken another lock on the original file that prevents a rename or deletion. If such a lock is present, the PUT OBJECT operation fails. Hence, checking for an existing shared mode lock on the original file representing the object can ensure that file storage protocol semantics are not impacted by the object storage protocol.

The present techniques can provide for data atomicity. An atomic transaction can be one where it is either fully implemented, or not implemented at all. The following are some examples of data atomicity in implementing multiple object storage operations.

Where multiple PUT OBJECT object storage operations are transferred on the same object storage key, the last operation that is committed will have its data persisted. Where a GET OBJECT object storage operation is performed concurrently with a PUT OBJECT object storage operation before the PUT OBJECT object storage operation commits, then the GET OBJECT object storage operation will get the entire data contents even if the PUT OBJECT object storage operation commits

Where a GET OBJECT object storage operation is performed concurrently with a PUT OBJECT object storage operation after the PUT OBJECT object storage operation commits, then the GET OBJECT object storage operation will get the entire data contents of the newly committed PUT OBJECT object storage operation.

Where a GET OBJECT object storage operation is performed concurrently with a DELETE FILE operation from a different protocol, the GET OBJECT object storage operation will get the entire data contents before the data was deleted. Multiple GET OBJECT object storage operations being called on the same key will have the same entire data contents.

### Example Architectures

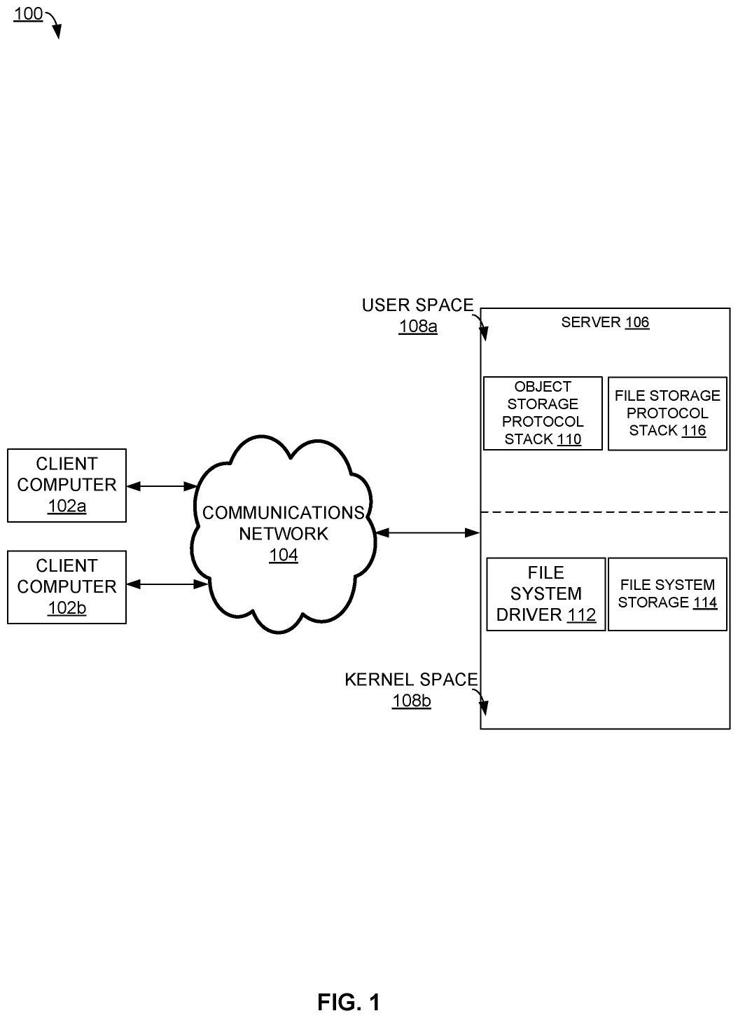

FIG. 1 illustrates an example system architecture 100 that can facilitate keeping object access on a file store consistent with other file protocols, in accordance with certain embodiments of this disclosure. As depicted, system architecture 100 comprises client computer 102a, client computer 102b, communications network 104, and server 106. In turn, server 106 can comprise user space 108a and kernel space 108b. Server 106 can also comprise object storage protocol stack 110 and file storage protocol stack 116, which operate in user space 108a. Server 106 can also comprise file system driver 112 and file system storage 114 that operate in kernel space 108b.

Kernel space 108b can generally comprise a memory area of server 106 utilized by an operating system kernel and some device drivers of server 106, where these are effectuated with computer-readable instructions. Then, user space 108a can generally comprise a memory area of server 106 utilized by other components of server 106, where these other components are effectuated with computer-readable instructions.

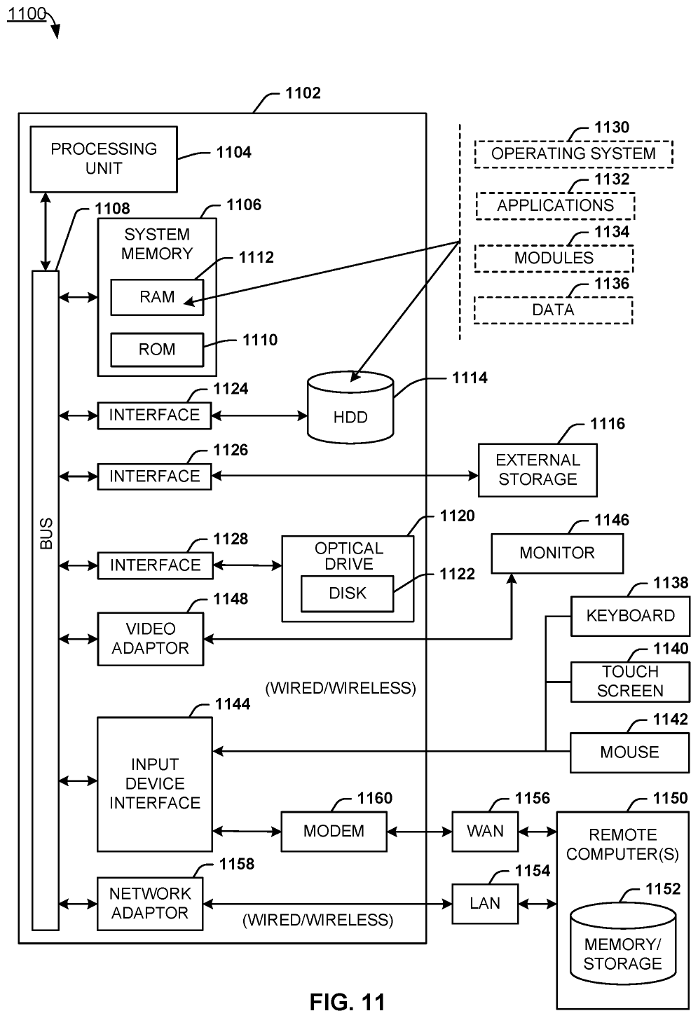

Each of client computer 102a, client computer 102b, and server 106 can be implemented with one or more instances of computer 1102 of FIG. 11. In some examples, server 106 comprises a distributed storage system that comprises multiple instances of computer 1102 of FIG. 11.

Communications network 104 can comprise a computer communications network, such as the INTERNET, or an isolated private computer communications network.

Each of client computer 102a and client computer 102b can send requests to server 106 to perform object storage operations on data (e.g., a GET OBJECT operation and/or a PUT OBJECT operation), as well as send requests to server 106 to perform file system operations on data (e.g., a READ OBJECT operation and/or a WRITE OBJECT operation). Client computer 102a and client computer 102b can send these requests to server 106 via communications network 104.

Server 106 can be configured to store and operate on data in a file system storage. So, where object storage operations are involved, server 106 can receive these object storage operations from client computer 102a and client computer 102b, and effectuate corresponding file system operations. Server 106 can receive these object storage operations from client computer 102a and client computer 102b at object storage protocol stack 110.

Object storage protocol stack 110 can receive an object storage operation, and convert it into one or more file storage operations. Object storage protocol stack 110 can then send these file storage operations one at a time in an IRP that is directed to file system driver 112 (which can provide access to file system storage 114).

Where object storage protocol stack 110 receives a request to perform a PUT OBJECT operation from client computer 102a or client computer 102b, server 106 can process this request as follows. Server 106 can determine that the PUT OBJECT operation is to operate on an object that corresponds to a first file of file system storage 114. Server 106 can then create a temporary file in file system storage 114, and perform a write to that file that temporary file. After writing to the temporary file, server 106 can lock the first file, rename the temporary file to the name of the first file (which can unlink the first file atomically), and release the lock on the first file. This approach can maintain consistency between file storage operations and object storage operations on a file system while implementing a PUT OBJECT object storage operation.

Where object storage protocol stack 110 receives a request to perform a GET OBJECT opreation from client computer 102a or client computer 102b, server 106 can process this request as follows. Server 106 can determine that the GET OBJECT operation is to operate on an object that corresponds to a first file of file system storage 114. Server 106 can lock the first file, read the first file, and then release the lock on the first file. This approach can maintain consistency between file storage operations and object storage operations on a file system while implementing a GET OBJECT object storage operation.

Similar to object storage protocol stack 110, file storage protocol stack 116 can receive a file storage operation, and send it in an IRP that is directed to file system driver 112 (which can provide access to file system storage 114).

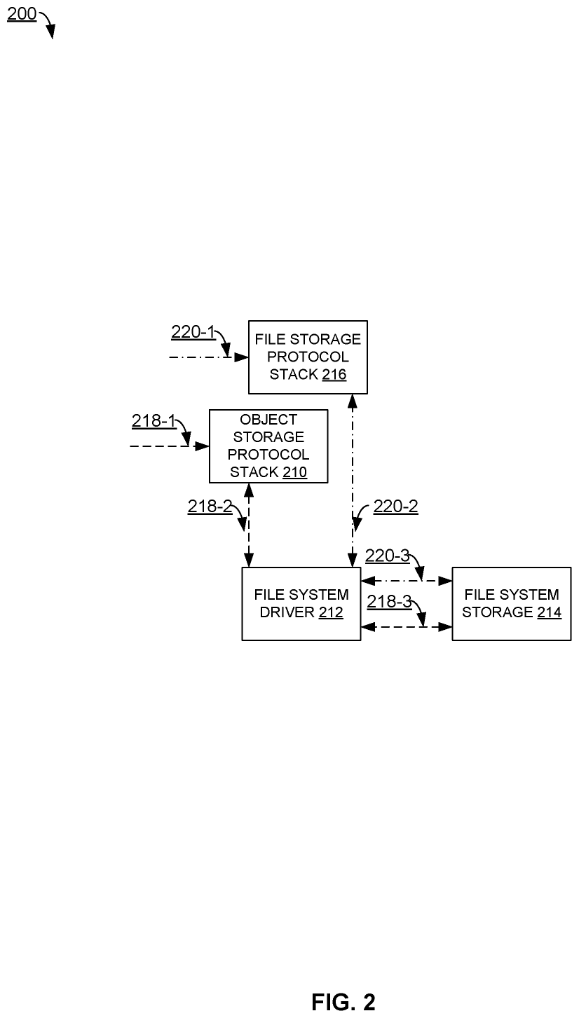

FIG. 2 illustrates another example system architecture 200 that can facilitate keeping object access on a file store consistent with other file protocols, in accordance with certain embodiments of this disclosure.

As depicted, system architecture 200 comprises object storage protocol stack 210, file system driver 212, file system storage 214, and file storage protocol stack 216. In some examples, object storage protocol stack 210 can be similar to object storage protocol stack 110 of FIG. 1; file system driver 212 can be similar to file system driver 112 of FIG. 1; file system storage 214 can be similar to file system storage 214 of FIG. 1; and file storage protocol stack 216 can be similar to file storage protocol stack 116 of FIG. 1.

The example of system architecture 200 can show how both object storage operations and file storage operations can be processed by system architecture 200 on the same file, and how system architecture 200 can maintain consistent behavior when processing both object storage operations and file storage operations on a given file.

In the example of FIG. 2, communication 218-1 comprises a request to perform an object storage operation that is received by object storage protocol stack 210 from a client computer and across a communications network (such as client computer 102a and communications network 104 of FIG. 1). In response, object storage protocol stack 208 sends an IRP 218-2 that indicates a corresponding file storage operation that is directed to file system driver 212. File system driver 212 can then instruct 218-3 file system storage 214 to perform the file system operation indicated by IRP 218-2, and receive an acknowledgment that it in turn relays to object storage protocol stack 210.

As for a file storage operation, communication 220-1 comprises a request to perform a file storage operation that is received by file storage protocol stack 216 from a client computer and across a communications network (such as client computer 102a and communications network 104 of FIG. 1). In response, file storage protocol stack 216 sends an IRP 220-2 that indicates a corresponding file storage operation that is directed to file system driver 212. File system driver 212 can then instruct 220-3 file system storage 214 to perform the file system operation indicated by IRP 220-2, and receive an acknowledgment that it in turn relays to file storage protocol stack 216.

These object storage operations and file storage operations can both be implemented on file system storage 214, and they can both be implemented on the same file in file system storage 214. For instance, a PUT OBJECT object storage operation can be performed on a first file, and while that is being processed, a DELETE FILE file storage operation can be processed for that first file.

### Example Process Flows

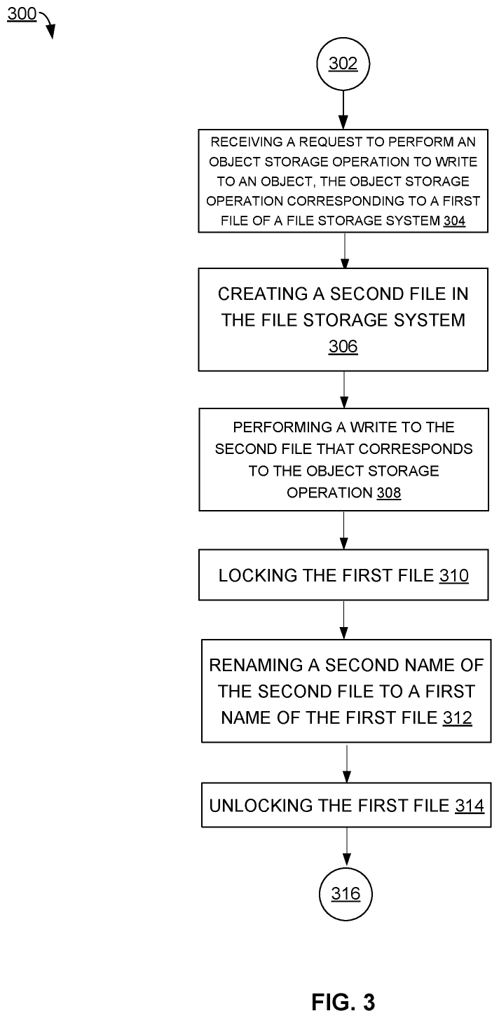

FIG. 3 illustrates an example process flow 300 for processing a PUT OBJECT object storage operation, as part of facilitating keeping object access on a file store consistent with other file protocols, in accordance with certain embodiments of this disclosure. In some examples, aspects of process flow 300 can be implemented by server 120 of FIG. 1, or computing environment 1100 of FIG. 11.

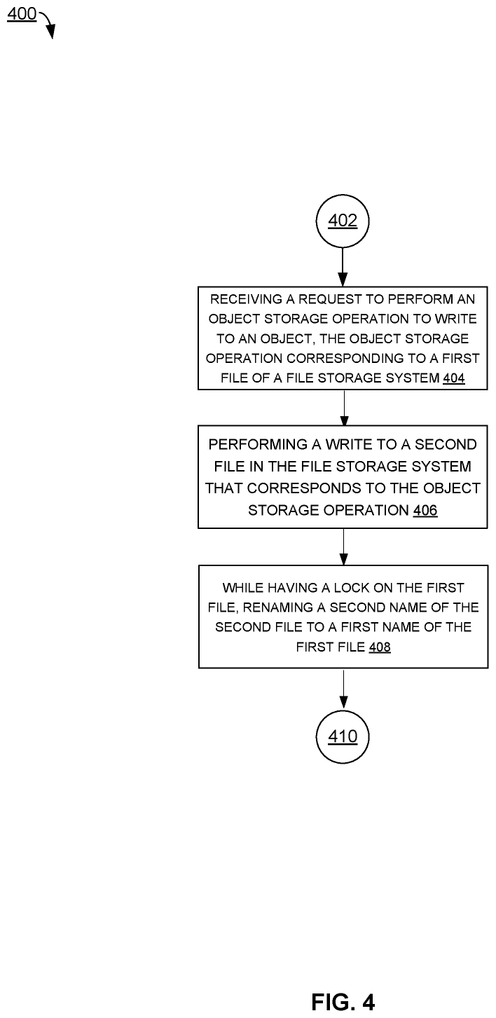

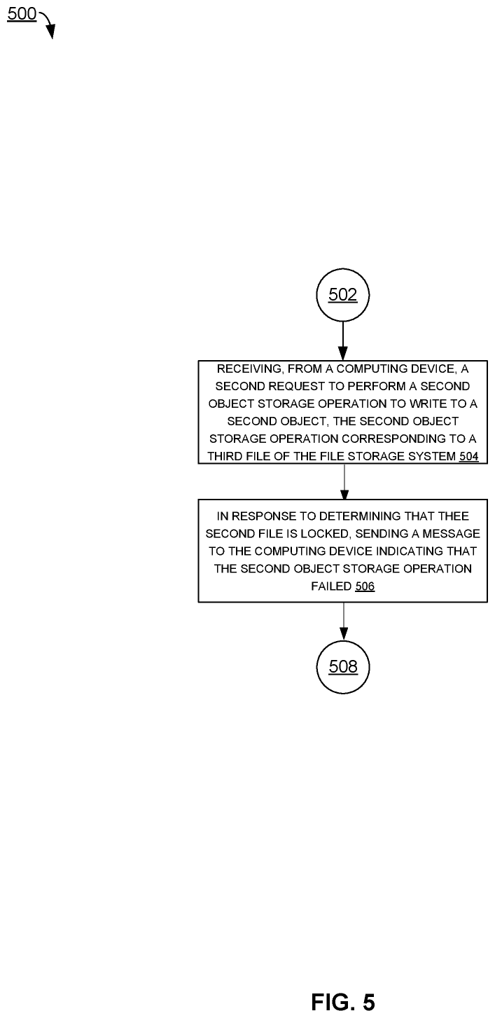

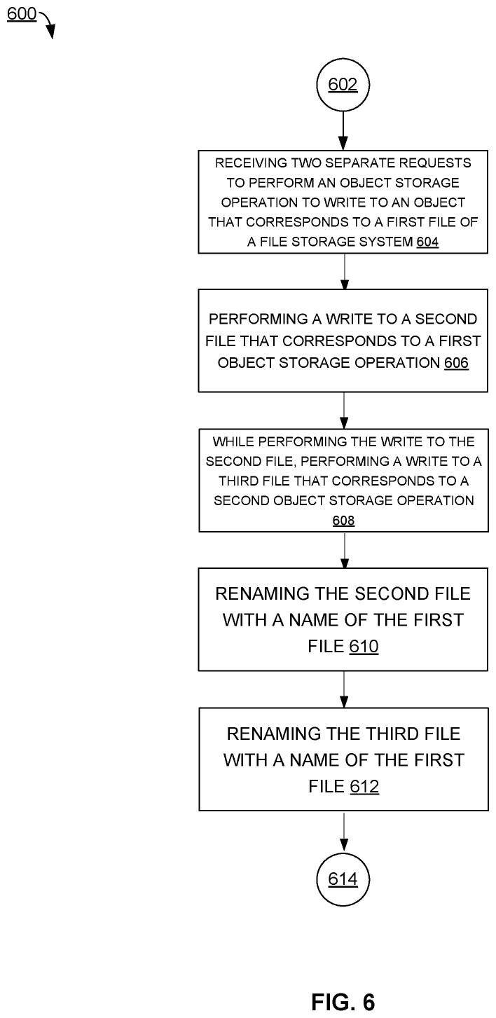

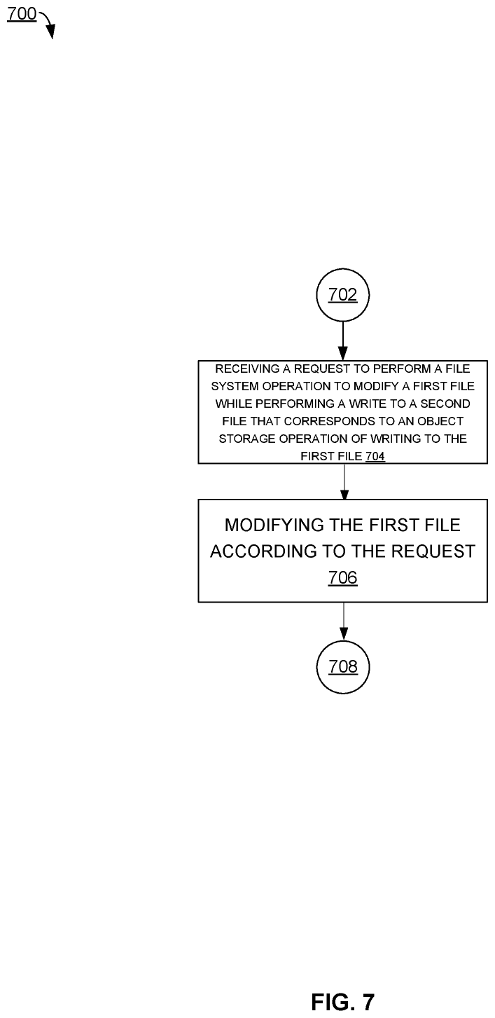

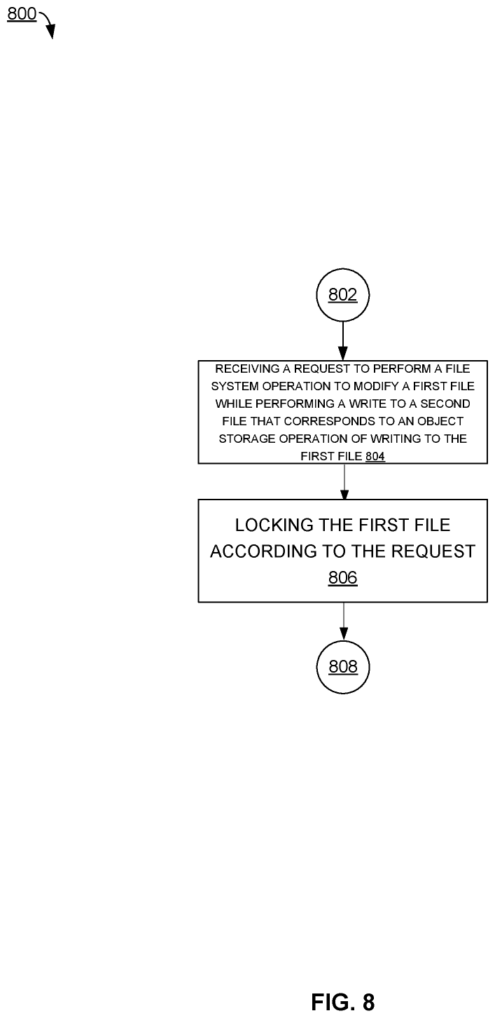

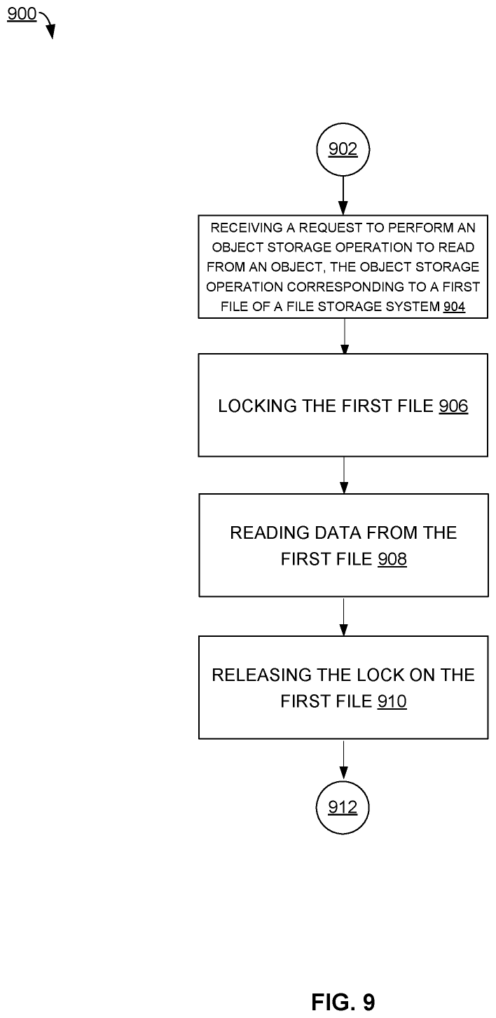

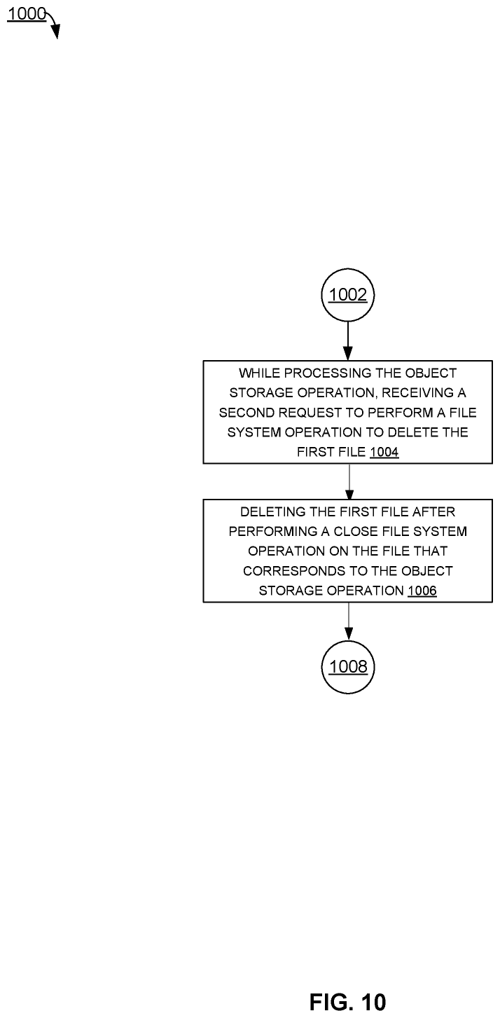

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with aspects of one or more of process flow 400 of FIG. 4, process flow 500 of FIG. 5, process flow 600 of FIG. 6, process flow 700 of FIG. 7, process flow 800 of FIG. 8, process flow 900 of FIG. 9, and process flow 1000 of FIG. 10.

Process flow 300 begins with 302, and moves to operation 304.

Operation 304 depicts Operation 304 depicts receiving a request to perform an object storage operation to write to an object, the object storage operation corresponding to a first file of a file system storage. In some examples, this can be a request to perform a PUT OBJECT object storage operation that is sent by client computer 102a of FIG. 1 and received by server 106. The PUT OBJECT operation is an operation on an object storage system. Where server 106 stores data in a file system, server 106 can determine one or more files that correspond to the PUT OBJECT operation, and the identified object.

After operation 304, process flow 300 moves to operation 306.

Operation 306 depicts creating a second file in the file system storage. This second file can be a temporary file that is different than the first file. The write for the PUT OBJECT can ultimately end up as the first file, and this temporary second file can be created as an intermediary step.

Creating a temporary file can comprise file system driver 112 of FIG. 1 performing an OPEN FILE operation on a new file of file system storage 114.

After operation 306, process flow 300 moves to operation 308.

Operation 308 depicts performing a write to the second file that corresponds to the object storage operation. That is, the data that is to be written as part of a PUT OBJECT object storage operation can be written to this temporary second file.

After operation 308, process flow 300 moves to operation 310.

Operation 310 depicts locking the first file. In some examples, locking of first file is performed after completing the performing the write to the second file. This can be done to permit other operations to be performed on the first file while the second file is being written to.

Operation 310 can comprise checking to see if there is a different lock on the first file. In some examples, this can include checking for an existing lock on the target file name if it has deny delete. In examples where it does have deny delete, the PUT OBJECT operation of process flow 300 can be terminated without successfully implementing the PUT OBJECT operation. The lock of operation 310 can be a shared mode lock.

There can be examples where locking the first file (and then unlocking the first file in operation 316) can be omitted. For example, where the first file does not already exist, and will be created as part of implementing this object storage operation to write to an object, then it can be that this first file that does not yet exist is not locked.

After operation 310, process flow 300 moves to operation 312.

Operation 312 depicts renaming a second name of the second file to a first name of the first file. An operation of renaming over the first file with the second file can cause the first file to be deleted in the act of renaming the second file to have the first file's namespace. Additionally, renaming the second file to the first file's name can remove the first file in an atomic way. This can be effectuated by file system driver 112 of FIG. 1 instructing file system storage 114 to rename the second file.

In some examples, operation 312 can comprise deleting a namespace reference to the first file. For example, where there is a concurrent opener to the first file, and a PUT object operation happens, then the first file can still exist, but the reference to the first file is gone.

After operation 312, process flow 300 moves to operation 314.

Operation 314 depicts unlocking the first file. This can be the lock placed on the first file in operation 310. As discussed with operation 310, there can be examples where operation 316 (as well as the counterpart of locking the first file in

In some examples, a second object storage operation to write to the object is performed concurrently with the first object storage operation. That is, multiple object storage clients can modify the same object concurrently.

After operation 314, process flow 300 moves to 316, where process flow 300 ends.

FIG. 4 illustrates another example process flow 400 for processing a PUT OBJECT object storage operation, as part of facilitating keeping object access on a file store consistent with other file protocols, in accordance with certain embodiments of this disclosure. In some examples, aspects of process flow 400 can be implemented by server 120 of FIG. 1, or computing environment 1100 of FIG. 11.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with aspects of one or more of process flow 300 of FIG. 3, process flow 500 of FIG. 5, process flow 600 of FIG. 6, process flow 700 of FIG. 7, process flow 800 of FIG. 8, process flow 900 of FIG. 9, and process flow 1000 of FIG. 10.

Process flow 400 begins with 402, and moves to operation 404.

Operation 404 depicts receiving a request to perform an object storage operation to write to an object, the object storage operation corresponding to a first file of a file storage system. In some examples, operation 404 can be implemented in a similar manner as operation 304 of FIG. 3.

After operation 404, process flow 400 moves to operation 406.

Operation 406 depicts performing a write to a second file in the file storage system that corresponds to the object storage operation. In some examples, operation 406 can be implemented in a similar manner as operation 306 of FIG. 3, or as operation 304 and operation 306 of FIG. 3.

After operation 406, process flow 400 moves to operation 408.

Operation 408 depicts, while having a lock on the first file, renaming a second name of the second file to a first name of the first file.

In some examples, operation 408 is performed after completing the performing the write to the second file. In some examples, operation 408 can be implemented in a similar manner as operation 310, operation 312, operation 314, and operation 316 of FIG. 3.

There can be examples where the first file does not exist until the second file is renamed to a first name of the first file. In such examples, locking this first file that does not yet exist can be omitted.

After operation 408, process flow 400 moves to 410, where process flow 400 ends.

FIG. 5 illustrates an example process flow 500 for processing a PUT OBJECT object storage operation when a corresponding file is locked, as part of facilitating keeping object access on a file store consistent with other file protocols, in accordance with certain embodiments of this disclosure. In some examples, aspects of process flow 500 can be implemented by server 120 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with aspects of one or more of process flow 300 of FIG. 3, process flow 400 of FIG. 4, process flow 600 of FIG. 6, process flow 700 of FIG. 7, process flow 800 of FIG. 8, process flow 900 of FIG. 9, and process flow 1000 of FIG. 10.

Process flow 500 begins with 502, and moves to operation 504.

Operation 504 depicts receiving, from a computing device, a request to perform an object storage operation to write to an object, the object storage operation corresponding to a file of the file storage system. In some examples, operation 504 can be implemented in a similar manner as operation 304 of FIG. 3.

After operation 504, process flow 500 moves to operation 506.

Operation 506 depicts, in response to determining that the file is locked, sending a message to the computing device indicating that the object storage operation failed. That is, a PUT OBJECT operation can fail when the corresponding file is locked by another entity. This behavior can maintain consistency between object storage operations and file storage operations.

In some examples, a set of locks for files can be maintained, and determining whether the file is locked can comprise querying this set. In other examples, determining whether the file is locked can comprise attempting to take an exclusive lock on the file. Where taking the exclusive lock fails, this can indicate that there is a pre-existing lock on the file.

In some examples, the computing device can comprise client computer 102a or client computer 102b of FIG. 1, and the message can be sent by server 106 via communications network 104.

After operation 506, process flow 500 moves to 508, where process flow 500 ends.

FIG. 6 illustrates an example process flow 600 for processing concurrent PUT OBJECT object storage operations, as part of facilitating keeping object access on a file store consistent with other file protocols, in accordance with certain embodiments of this disclosure. In some examples, aspects of process flow 600 can be implemented by server 120 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with aspects of one or more of process flow 300 of FIG. 3, process flow 400 of FIG. 4, process flow 500 of FIG. 5, process flow 700 of FIG. 7, process flow 800 of FIG. 8, process flow 900 of FIG. 9, and process flow 1000 of FIG. 10.

Operation 604 depicts receiving two separate requests to perform an object storage operation to write to an object that corresponds to a first file of a file storage system. In some examples, operation 604 can be implemented in a similar manner as two instances of operation 304 of FIG. 3. In some examples, these two requests can be received from different entities (e.g., client computer 102a and client computer 102b of FIG. 1) or the same entity (e.g., client computer 102a ).

These two requests can correspond to writing to the same file. These two requests be received at different times, but in close-enough succession that a first write request is still being processed when a second write request is received. Then, the two write requests can be processed concurrently.

In some examples, processing a PUT OBJECT write request comprises first writing to a temporary file, then renaming the temporary file with the name of the target file, so that the written data is ultimately stored under the name of the target file. In such examples, concurrently processing such PUT OBJECT write requests to one file can comprise concurrently writing to temporary files—one temporary file for each request.

After operation 604, process flow 600 moves to operation 606.

Operation 606 depicts performing a write to a second file that corresponds to a first object storage operation. In some examples, operation 608 can be implemented in a similar manner as operation 306 and operation 308 of FIG. 3. After operation 606, process flow 600 moves to operation 608.

Operation 608 depicts, while performing the write to the second file, performing a write to a third file that corresponds to a second object storage operation. In some examples, operation 608 can be implemented in a similar manner as operation 306 and operation 308 of FIG. 3, and where the writing is to a different temporary file (a third file) than the temporary file (the second file) in operation 606. After operation 608, process flow 600 moves to operation 610.

Operation 610 depicts renaming the second file with a name of the first file. In some examples, operation 610 can be implemented in a similar manner as operation 314 of FIG. 3. After operation 610, process flow 600 moves to operation 612.

Operation 612 depicts renaming the third file with a name of the first file. In some examples, operation 610 can be implemented in a similar manner as operation 314 of FIG. 3. As depicted, operation 610 involves effectively writing the data of a first request to the first file, and then operation 612 involves effectively writing the data of a second request to the first file, thereby overwriting the data from the firs request.

It can be appreciated that operations 610 and 612 can depicts an example where the first object storage operation completes before the second object storage operation. So, the first file can be written to with the data for the first object storage operation, and then when the second object storage operation completes, the first file can be written to with the data for the second object storage operation, thereby overwriting the data from the first object storage operation. There can be examples where the second object storage operation completes before the first object storage operation completes.

After operation 612, process flow 600 moves to 614, where process flow 600 ends.

FIG. 7 illustrates an example process flow 700 for processing a file storage protocol modification operation concurrent with a PUT OBJECT object storage operation on the same file, as part of facilitating keeping object access on a file store consistent with other file protocols, in accordance with certain embodiments of this disclosure. In some examples, aspects of process flow 700 can be implemented by server 120 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with aspects of one or more of process flow 300 of FIG. 3, process flow 400 of FIG. 4, process flow 500 of FIG. 5, process flow 600 of FIG. 6, process flow 800 of FIG. 8, process flow 900 of FIG. 9, and process flow 1000 of FIG. 10.

Process flow 700 begins with 702 and moves to operation 704.

Operation 704 depicts receiving a request to perform a file system operation to modify a first file while performing a write to a second file that corresponds to an object storage operation of writing to the first file. A system, such as server 106 of FIG. 1, can be implementing a PUT OBJECT object storage operation on a first file. As part of that, the server can initially write the PUT OBJECT data to a second file, and then will later rename the second file with the first file's name While this is occurring, the server can receive a file system operation to modify the first file, such as by writing to at least a portion of it, or deleting it.

In some examples, the object storage operation of operation 704 can be implemented in a similar manner as described with respect to process flow 300 of FIG. 3, where operation 704 involves a fi. After operation 704, process flow 700 moves to operation 706.

Operation 706 depicts modifying the first file according to the request. In some examples, file system driver 112 of FIG. 1 can request that a modification be made to the first file that is stored in file system storage 114. This modification can include writing to the first file or deleting the first file.

After operation 706, process flow 700 moves to 708, where process flow 700 ends.

FIG. 8 illustrates an example process flow 800 for processing a file storage protocol lock operation concurrent with a PUT OBJECT object storage operation on the same file, as part of facilitating keeping object access on a file store consistent with other file protocols, in accordance with certain embodiments of this disclosure. In some examples, aspects of process flow 800 can be implemented by server 120 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with aspects of one or more of process flow 300 of FIG. 3, process flow 400 of FIG. 4, process flow 500 of FIG. 5, process flow 600 of FIG. 6, process flow 700 of FIG. 7, process flow 900 of FIG. 9, and process flow 1000 of FIG. 10.

Operation 804 depicts receiving a request to perform a file system operation to modify a first file while performing a write to a second file that corresponds to an object storage operation of writing to the first file. In some examples, operation 804 can be implemented in a similar manner as operation 704 of FIG. 7. After operation 804, process flow 800 moves to operation 806.

Operation 806 depicts locking the first file according to the request. In some examples, file system driver 112 of FIG. 1 can request that a lock be placed on the first file that is stored in file system storage 114. This lock can be similar to a lock as described with respect to operation 310 of FIG. 3. In some examples, the lock can be an exclusive lock, or a nonexclusive lock. After operation 806, process flow 800 moves to 808, where process flow 800 ends.

FIG. 9 illustrates an example process flow 900 for processing a GET OBJECT object storage operation, as part of facilitating keeping object access on a file store consistent with other file protocols, in accordance with certain embodiments of this disclosure. In some examples, aspects of process flow 900 can be implemented by server 120 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with aspects of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and process flow 1000 of FIG. 10.

Operation 904 depicts receiving a request to perform an object storage operation to read from an object, the object storage operation corresponding to a first file of a file storage system. This request can be received similar to the request of operation 304 of FIG. 3. In operation 904, the request can identify a GET OBJECT object storage operation, in comparison to a PUT OBJECT object storage operation that can be the subject of the request in operation 304. After operation 904, process flow 900 moves to operation 906.

Operation 906 depicts locking the first file. In some examples, operation 906 can be implemented in a similar manner as operation 310 of FIG. 3. The first file can be locked with a shared mode lock. In some examples, a shared mode lock denies concurrent write access to the first file. In some examples, a shared mode lock permits concurrent read access to the first file.

After operation 906, process flow 900 moves to operation 908.

Operation 908 depicts reading data from the first file. In some examples, reading data from the first file can comprise file system driver 112 of FIG. 1 retrieving data for the first file from file system storage 114, and server 106 sending this retrieved data to an entity that originated the request of operation 904—such as client computer 102a.

After operation 908, process flow 900 moves to operation 910.

Operation 910 depicts releasing the lock on the first file. In some examples, operation 910 can be implemented in a similar manner as operation 316 of FIG. 3. After operation 910, process flow 900 moves to 912, where process flow 900 ends.

FIG. 10 illustrates an example process flow 1000 for processing a DELETE FILE file storage operation concurrent with a GET OBJECT object storage operation on the same file, as part of facilitating keeping object access on a file store consistent with other file protocols, in accordance with certain embodiments of this disclosure. In some examples, aspects of process flow 1000 can be implemented by server 120 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 100 can be implemented in conjunction with aspects of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and process flow 900 of FIG. 9.

Operation 1004 depicts, while processing the object storage operation, receiving a second request to perform a file system operation to delete the first file. In some examples, operation 1004 can be implemented in a similar manner as operation 704 of FIG. 4. After operation 1004, process flow 1000 moves to operation 1006.

Operation 1006 depicts deleting the first file after performing a close file system operation on the file that corresponds to the object storage operation. That is, the object storage operation can be permitted to complete. In some examples, the object storage operation completes when object storage protocol stack 110 of FIG. 1 sends a close file operation to file system driver 112, and that file is closed. Once the file is closed for the object storage operation, then the file system delete operation can be implemented for that file.

In some examples, this delete operation can be queued up—the DELETE FILE operation can wait until there are no open file handles on the file. But the requesting entity (e.g., client computer 102a of FIG. 1) can be informed that the DELETE FILE operation was performed after the DELETE FILE operation was queued up, and before it was implemented. In some examples, this can comprise sending a message to a computing device indicating that the first file is deleted before performing the deleting of the first file.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, aspects of computing environment 1100 can be used to implement aspects of client computer 102a, client computer 102b, and/or server 106 of FIG. 1. In some examples, computing environment 1100 can implement aspects of the process flows of FIGS. 3-9 to facilitate keeping object access on a file store consistent with other file protocols.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1194 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the first processor, facilitate performance of operations, comprising:
receiving a request to perform an object storage operation to write to an object, the object storage operation corresponding to a first file of a file storage system;
creating a second file in the file storage system;
performing a write to the second file that corresponds to the object storage operation; and
renaming a second name of the second file to a first name of the first file.

2. The system of claim 1, wherein the request comprises a first request, wherein the object storage operation comprises a first object storage operation, and wherein the operations further comprise:
receiving a second request to perform a second object storage operation to read from an object, the object storage operation corresponding to a target file that comprises the first file or a third file of the file storage system;
locking the target file;
reading data from the target file; and
releasing the lock on the target file.

3. The system of claim 1, wherein the request comprises a first request, wherein the object storage operation comprises a first object storage operation, and wherein the operations further comprise:
receiving, from a device, a second request to perform a second object storage operation to write to a second object, the second object storage operation corresponding to a third file of the file storage system;
in response to determining that the third file is locked, sending a message to the device indicating that the second object storage operation failed.

4. The system of claim 1, wherein the operations further comprise:
locking the first file after completing the performing the write to the second file; and
unlocking the first file after performing the renaming the second name of the second file to the first name of the first file.

5. The system of claim 1, wherein the object storage operation comprises a first object storage operation, and wherein a second object storage operation to write to the object is performed concurrently with the first object storage operation.

6. The system of claim 5, wherein the second object storage operation corresponds to the first file, and wherein performing a write to a third file that corresponds to the second object storage operation is performed concurrently with the performing the write to the second file that corresponds to the object storage operation.

7. The system of claim 1, wherein the request comprises a first request, and wherein the operations further comprise:
while performing the write to the second file that corresponds to the object storage operation, receiving a second request to perform a file system operation to modify the first file; and
modifying the first file according to the second request.

8. The system of claim 1, wherein the request comprises a first request, and wherein the operations further comprise:
while performing the write to the second file that corresponds to the object storage operation, receiving a second request to perform a file system operation to lock the first file; and
locking the first file according to the second request.

9. A method, comprising:
receiving, by a system comprising a processor, a request to perform an object storage operation to read from an object, the object storage operation corresponding to a first file of a file storage system;
locking, by the system, the first file;
reading, by the system, data from the first file; and
releasing, by the system, the lock on the first file.

10. The method of claim 9, wherein the request comprises a first request, and wherein the operations further comprise:
while processing the object storage operation, receiving, by the system, a second request to perform a file system operation to delete the first file; and
deleting, by the system, the first file after performing a close file system operation on the file that corresponds to the object storage operation.

11. The method of claim 10, wherein the second request is received from a computing device, and wherein the operations further comprise:
sending, by the system, a message to the computing device indicating that the first file is deleted before performing the deleting of the first file.

12. The method of claim 9, wherein the locking of the first file is performed with a shared mode lock.

13. The method of claim 12, wherein the shared mode lock denies concurrent write access to the first file.

14. The method of claim 12, wherein the shared mode lock permits concurrent read access to the first file.

15. The method of claim 9, wherein the object storage operation to read from the object comprises a GET operation.

16. A non-transitory computer-readable medium comprising instructions that, in response to execution, cause a system comprising a processor to perform operations, comprising:
receiving a request to perform an object storage operation to write to an object, the object storage operation corresponding to a first file of a file storage system;
performing a write to a second file in the file storage system that corresponds to the object storage operation; and
renaming over the first file with the second file.

17. The non-transitory computer-readable medium of claim 16, wherein the operations further comprise:
determining whether there is a pre-existing lock on the first file and locking the first file before performing the renaming over the first file with the second file.

18. The non-transitory computer-readable medium of claim 16, wherein the renaming of the first file is performed after completing the performing the write to the second file.

19. The non-transitory computer-readable medium of claim 16, wherein the object storage operation to write to the object comprises a PUT operation.

20. The non-transitory computer-readable medium of claim 16, wherein the request comprises a first request, wherein the object storage operation comprises a first object storage operation, and wherein the operations further comprise:
receiving a second request to perform a second object storage operation to write to a second object, the second object storage operation corresponding to a third file of the file storage system;
in response to determining that the third file is locked, determining that the second object storage operation failed.
